(19) United States
(12) Patent Application Publication
(10) Pub. No.: US 2013/0212198 A1
(43) Pub. Date: Aug. 15, 2013

(54) METHODS AND SYSTEMS OF DYNAMIC MAIL SYNCHRONIZATION FOR MOBILE DEVICES

(71) Applicant: HTC CORPORATION, (US)

(72) Inventors: Chine-Nan Lin, Taoyuan County (TW); Ssu-Po Chin, Taoyuan County (TW); Hsin-Ti Chueh, Taoyuan County (TW)

(73) Assignee: HTC CORPORATION, Taoyuan County (TW)

(21) Appl. No.: 13/762,374

(22) Filed: Feb. 8, 2013

Related U.S. Application Data
(60) Provisional application No. 61/598,348, filed on Feb. 14, 2012.

(51) Int. Cl. H04L 12/58

(52) U.S. Cl. CPC H04L 51/22
USPC 709/206

(57) ABSTRACT

Systems and methods of dynamic mail synchronization for mobile devices are provided. At least one state of a mail box corresponding to a mail application on the electronic device is monitored, wherein the mail application has a predefined mail synchronization mechanism for checking and receiving mails from a server. It is determined whether the monitored state reaches a corresponding threshold value. When the monitored state reaches the corresponding threshold value, the predefined mail synchronization mechanism of the mail application is adjusted, such that the mail application periodically checks and receives mails from the server based on the adjusted mail synchronization mechanism.

### CROSS-REFERENCE TO RELATED APPLICATION

This application claims the priority benefits of U.S. provisional application Ser. No. 61/598,348, filed on Feb. 14, 2012. The entirety of the above-mentioned patent application is hereby incorporated by reference herein and made a part of this specification.

### BACKGROUND OF THE INVENTION

1. Field of the Invention

The disclosure relates generally to mail management, and, more particularly to methods and systems of dynamic mail synchronization for mobile devices.

2. Description of the Related Art

Recently, portable devices, such as handheld devices, have become more and more technically advanced and multifunctional. For example, a handheld device may have telecommunications capabilities, e-mail message capabilities, an advanced address book management system, a media playback system, and various other functions. Due to increased convenience and functions of the devices, these devices have become necessities of life.

In some cases, a mobile device may be installed with a mail application. Additionally, the mobile device may have network connection capabilities. The mail application can connect to a mail server via a network using the network connection capabilities, and check and receive email messages from the mail server. In general, the mail application can set a mail synchronization mechanism for checking and receiving email messages from a server.

Conventionally, the mail synchronization mechanism may be a periodical checking mechanism or a push mail mechanism. In the periodical checking mechanism, the mail application will periodically check and receive email messages from the mail server according to a predefined period. It is noted that, the predefined period can be set by users. However, once the predefined period is set, the mail application will execute according to the predefined period until the predefined period is modified. In some cases, a user of a mobile device may infrequently have email messages. When the predefined period of the periodical checking mechanism is set too short, the mail checking process always makes a futile effort, and the power of the mobile device may be wasted. Therefore, some users may employ the push mail mechanism for mail synchronization. In the push mail mechanism, once an unread mail is received by the mail server, the mail will actively inform the mail application with the information regarding the unread mail. However, in the push mail mechanism, although the mail application does not require to actively checks email messages, the mail application still needs to maintain Heartbeats with the mail server. The maintenance of Heartbeats still needs consumption of the power of the mobile device.

### BRIEF SUMMARY OF THE INVENTION

Methods and systems of dynamic mail synchronization for mobile devices are provided.

In an embodiment of a method of dynamic mail synchronization for mobile devices, at least one state of a mail box corresponding to a mail application on the electronic device is monitored, wherein the mail application has a predefined mail synchronization mechanism for checking and receiving mails from a server. It is determined whether the monitored state reaches a corresponding threshold value. When the monitored state reaches the corresponding threshold value, the predefined mail synchronization mechanism of the mail application is adjusted, such that the mail application periodically checks and receives mails from the server based on the adjusted mail synchronization mechanism.

An embodiment of a system of dynamic mail synchronization for mobile devices includes a storage unit and a processing unit. The storage unit includes a mail box corresponding to a mail application, wherein the mail application has a predefined mail synchronization mechanism for checking and receiving mails from a server. The processing unit monitors at least one state of the mail box, and determines whether the monitored state reaches a corresponding threshold value. When the monitored state reaches the corresponding threshold value, the processing unit adjusts the predefined mail synchronization mechanism of the mail application, such that the mail application periodically checks and receives mails from the server based on the adjusted mail synchronization mechanism.

In some embodiments, the at least one state can be a number of unread mails in the mail box, a time interval between two successive mails, a period between receiving the first unread mail and the mail application is been launched, and/or a period between receiving the first unread mail and at least one mail is been read.

In some embodiments, when the number of unread mails in the mail box is greater, a synchronization period of the mail synchronization mechanism is set longer. In some embodiments, when the time interval between two successive mails is longer, a synchronization period of the mail synchronization mechanism is set longer. In some embodiments, when the period between receiving the first unread mail and the mail application is been launched is longer, a synchronization period of the mail synchronization mechanism is set longer. In some embodiments, when the period between receiving the first unread mail and at least one mail is been read is longer, a synchronization period of the mail synchronization mechanism is set longer.

In some embodiments, when at least one unread mail in the mail box is been read or when the mail application is opened, the mail synchronization mechanism of the mail application is returned to the predefined mail synchronization mechanism. In some embodiments, the at least one unread mail in the mail box is determined to be read when a title or a body of the at least one unread mail is read.

In some embodiments, in the method for adjusting the mail synchronization mechanism of the mail application, at least a first synchronization period setting and a second synchronization period setting are provided, wherein the second synchronization period setting is longer than the first synchronization period setting. When the monitored state reaches the corresponding threshold value, a synchronization period of the mail synchronization mechanism is set to the first synchronization period setting. It is determined whether the first synchronization period setting expires. When the first synchronization period setting expires, the synchronization period of the mail synchronization mechanism is set to the second synchronization period setting. In some embodiments, when the first synchronization period setting expires, the mail application first checks and receives mails from the server based on the first synchronization period setting, and thereafter the synchronization period of the mail synchronization mechanism is set to the second synchronization period setting.

In some embodiments, the predefined mail synchronization mechanism of the mail application can be a push mail mechanism, and the mail application periodically checks and receives mails from the server based on the adjusted mail synchronization mechanism when at least one unread mail is received.

Methods of dynamic mail synchronization for mobile devices may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system of dynamic mail synchronization for mobile devices of the invention.

FIG. 2 is a schematic diagram illustrating an embodiment of a mobile device of the invention.

FIG. 3 is a flowchart of an embodiment of a method of dynamic mail synchronization for mobile devices of the invention.

FIG. 4 is a flowchart of another embodiment of a method of dynamic mail synchronization for mobile devices of the invention.

FIG. 5 is a flowchart of an embodiment of a method for adjusting the mail synchronization mechanism of the mail application of the invention.

### DETAILED DESCRIPTION OF THE INVENTION

Methods and systems of dynamic mail synchronization for mobile devices are provided.

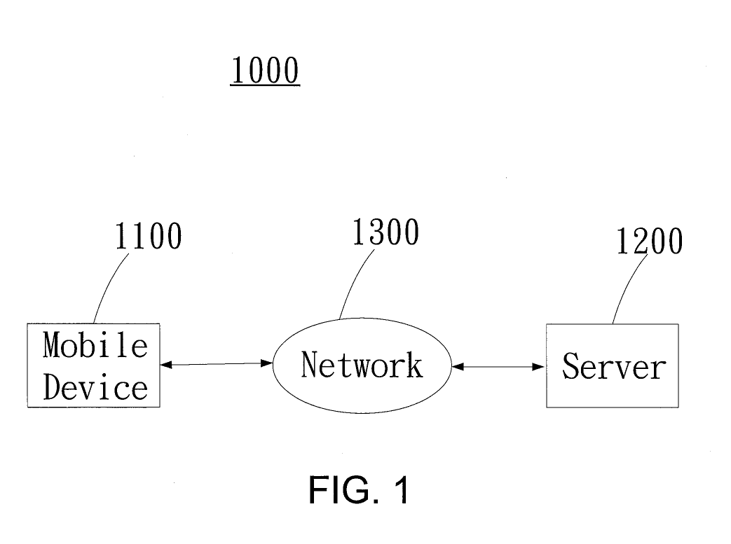

FIG. 1 is a schematic diagram illustrating an embodiment of a system of dynamic mail synchronization for mobile devices of the invention. The system of dynamic mail synchronization for mobile devices 1000 comprises a mobile device 1100 and a server 1200. It is understood that, the mobile device 1100 may have network connection capabilities, and connect to the server 1200 via a network 1300 using the network connection capabilities. In some embodiments, the server 1200 may be a mail server, which manages users' email accounts corresponding to respective mobile devices. The mobile device 1100 can connect to the server 1200, and check and receive email messages from the server 1200. It is understood that, in some embodiments, the network 1300 may be an Internet, a telecommunication network, a LAN, a WAN, a Wi-Fi network, a Bluetooth network, and others.

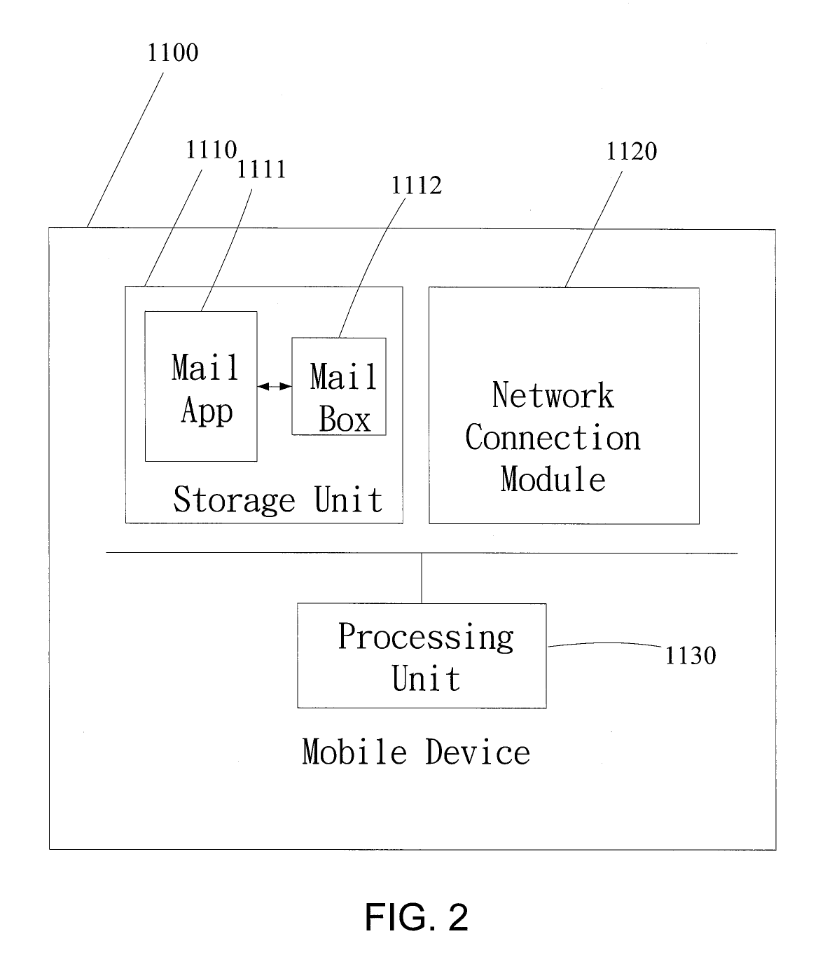

FIG. 2 is a schematic diagram illustrating an embodiment of a mobile device of the invention. It is understood that, the mobile device may be a PDA (Personal Digital Assistant), a smart phone, a mobile phone, an MID (Mobile Internet Device, MID), a Netbook, a GPS (Global Positioning System), or other handheld devices. As shown in FIG. 2, the mobile device 1100 comprises a storage unit 1110, a network connection module 1120, and a processing unit 1130. It is understood that, in some embodiments, the storage unit 1110 may be a built-in memory or an external memory of the mobile device 1100. The storage unit 1110 comprises at least a mail application 1111, and a mail box 1112 corresponding to a user account in the mail application 1111. The mail application 1111 manages and controls related logics and operations for email messages, and stores email messages received from the server 1200 in the mail box 1112. The network connection module 1120 can implement at least one network connection protocol, such that the mobile device 1100 can connect to the network 1300 via the network connection module 1120. The processing unit 1130 can control related components of the mobile device 1100, and perform the methods of dynamic mail synchronization for mobile devices of the invention, which will be discussed further in the following paragraphs. It is understood that, in some embodiments, the mobile device 1100 can further comprise a display unit (not shown in FIG. 2). The display unit can display related figures and interfaces, and related data. It is understood that, in some embodiments, the display unit may be a screen integrated with a touch-sensitive device (not shown). The touch-sensitive device has a touch-sensitive surface comprising sensors in at least one dimension to detect contact and movement of an input tool, such as a stylus or finger on the touch-sensitive surface. That is, users can directly input related data via the display unit.

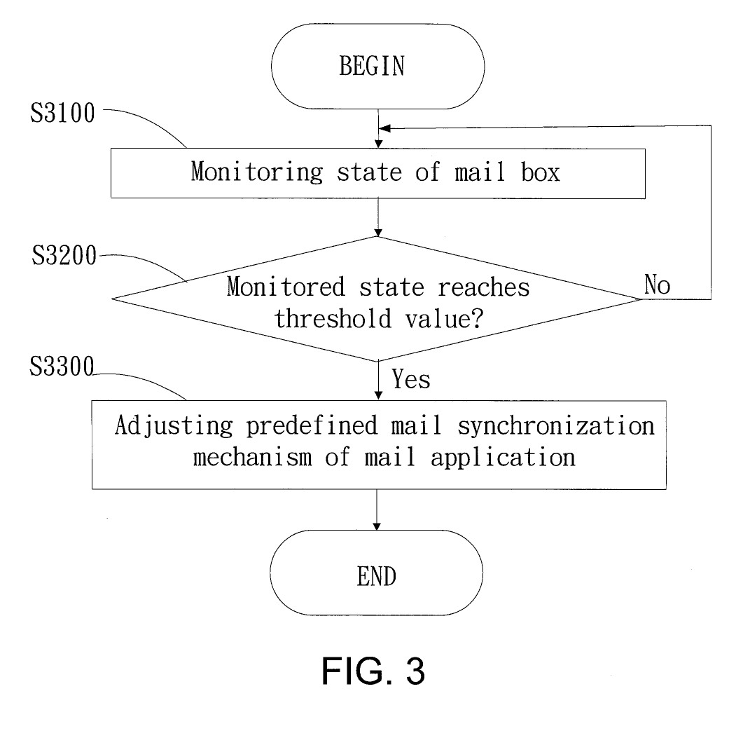

FIG. 3 is a flowchart of an embodiment of a method of dynamic mail synchronization for mobile devices of the invention. The method of dynamic mail synchronization for mobile devices can be used in an electronic device, such as mobile devices such as a PDA, a smart phone, a mobile phone, an MID, a Netbook, a GPS, or other handheld devices.

In step S3100, at least one state of a mail box corresponding to a mail application on the electronic device is monitored. It is understood that, in some embodiments, the at least one state can be a number of unread mails in the mail box, a time interval between two successive mails, a period between receiving the first unread mail and the mail application is been launched, a period between receiving the first unread mail and at least one mail is been read, and/or others. It is noted that, the mail application may have a predefined mail synchronization mechanism for checking and receiving mails from a server. It is understood that, in some embodiments, the predefined mail synchronization mechanism may be a periodical checking mechanism or a push mail mechanism. In step S3200, it is determined whether the monitored state reaches a corresponding threshold value. It is understood that, in some embodiments, the respective state may define a respective threshold value. When the monitored state does not reach the corresponding threshold value (No in step S3200), the procedure returns to step 53100. When the monitored state reaches the corresponding threshold value (Yes in step S3200), in step S3300, the predefined mail synchronization mechanism of the mail application is adjusted, such that the mail application periodically checks and receives mails from the server based on the adjusted mail synchronization mechanism.

As described, the predefined mail synchronization mechanism may be a push mail mechanism. When the monitored state reaches the corresponding threshold value or at least one unread mail is received from the server, the mail application periodically checks and receives mails from the server based on the adjusted mail synchronization mechanism. It is understood that, in some embodiments, when at least one unread mail in the mail box is been read or when the mail application is opened, the mail synchronization mechanism of the mail application is returned to the predefined mail synchronization mechanism. In some embodiments, the at least one unread mail in the mail box is determined to be read when a title or a body of the at least one unread mail is read.

It is noted that, as described, the at least one state can be a number of unread mails in the mail box, a time interval between two successive mails, a period between receiving the first unread mail and the mail application is been launched, a period between receiving the first unread mail and at least one mail is been read, and/or others. In some embodiments, when the number of unread mails in the mail box is greater, a synchronization period of the mail synchronization mechanism can be set longer. In some embodiments, when the time interval between two successive mails is longer, a synchronization period of the mail synchronization mechanism can be set longer. In some embodiments, when the period between receiving the first unread mail and the mail application is been launched is longer, a synchronization period of the mail synchronization mechanism can be set longer. In some embodiments, when the period between receiving the first unread mail and at least one mail is been read is longer, a synchronization period of the mail synchronization mechanism can be set longer.

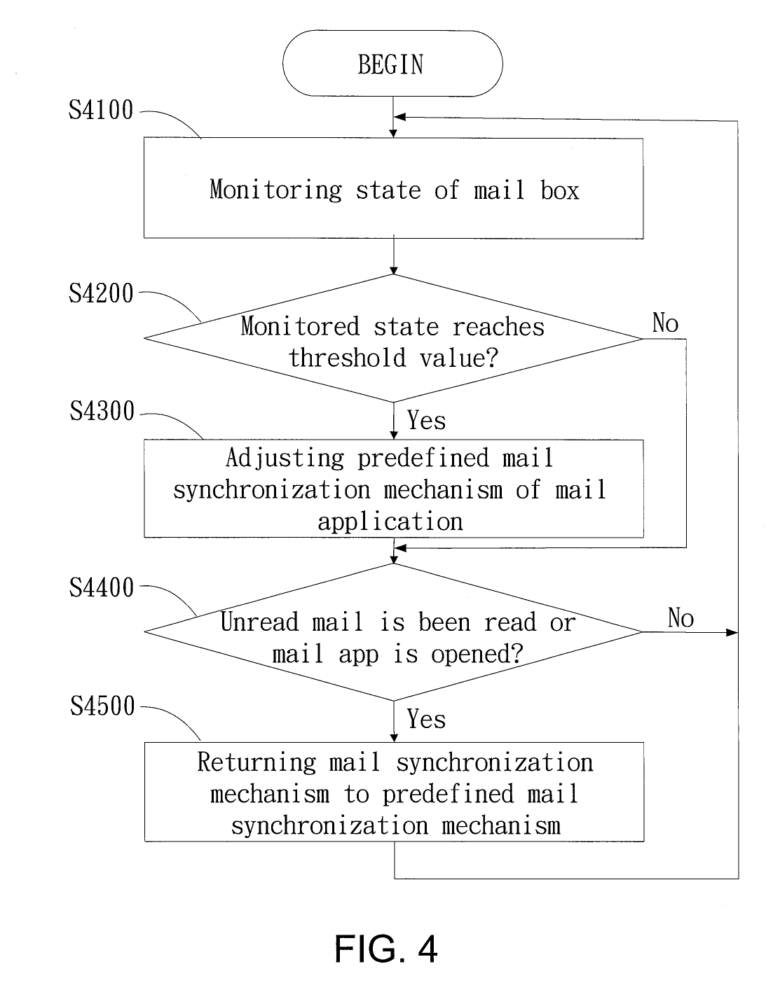

FIG. 4 is a flowchart of another embodiment of a method of dynamic mail synchronization for mobile devices of the invention. The method of dynamic mail synchronization for mobile devices can be used in an electronic device, such as mobile devices such as a PDA, a smart phone, a mobile phone, an MID, a Netbook, a GPS, or other handheld devices.

In step S4100, at least one state of a mail box corresponding to a mail application on the electronic device is monitored. Similarly, in some embodiments, the at least one state can be a number of unread mails in the mail box, a time interval between two successive mails, a period between receiving the first unread mail and the mail application is been launched, a period between receiving the first unread mail and at least one mail is been read, and/or others. It is noted that, the mail application may have a predefined mail synchronization mechanism for checking and receiving mails from a server. It is understood that, in some embodiments, the predefined mail synchronization mechanism may be a periodical checking mechanism or a push mail mechanism. In step S4200, it is determined whether the monitored state reaches a corresponding threshold value. In some embodiments, the respective state may define a respective threshold value. When the monitored state does not reach the corresponding threshold value (No in step S4200), the procedure goes to step S4400. When the monitored state reaches the corresponding threshold value (Yes in step S4200), in step 54300, the predefined mail synchronization mechanism of the mail application is adjusted, such that the mail application periodically checks and receives mails from the server based on the adjusted mail synchronization mechanism. Then, in step 54400, it is determined whether at least one unread mail in the mail box is been read or when the mail application is opened. It is understood that, in some embodiments, the at least one unread mail in the mail box is determined to be read when a title or a body of the at least one unread mail is read. If no unread mail in the mail box is been read and the mail application is not opened (No in step S4400), the procedure returns to step 54100. If at least one unread mail in the mail box is been read or the mail application is opened (Yes in step S4400), in step S4500, the mail synchronization mechanism of the mail application is returned to the predefined mail synchronization mechanism, and the procedure returns to step 54100.

Similarly, the predefined mail synchronization mechanism may be a push mail mechanism. When the monitored state reaches the corresponding threshold value or at least one unread mail is received from the server, the mail application periodically checks and receives mails from the server based on the adjusted mail synchronization mechanism.

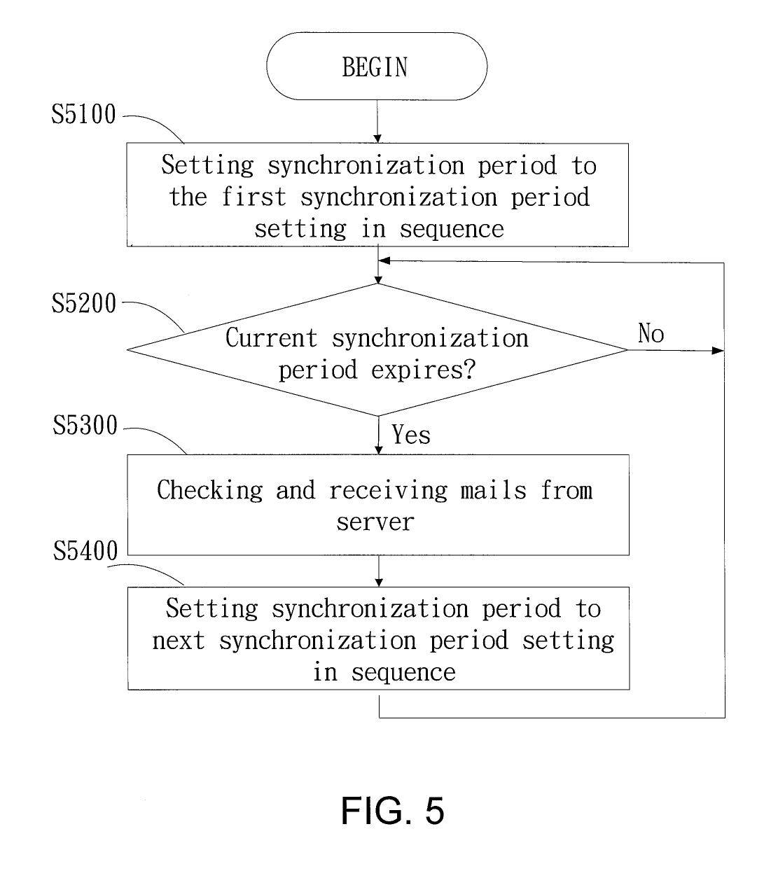

As described, when the monitored state reaches the corresponding threshold value, the predefined mail synchronization mechanism of the mail application will be adjusted. FIG. 5 is a flowchart of an embodiment of a method for adjusting the mail synchronization mechanism of the mail application of the invention. In the embodiment, a sequence of synchronization period settings can be provided, wherein the rear synchronization period setting may have a longer period than the former synchronization period setting in the sequence. For example, five synchronization period settings may be in the sequence, and the synchronization period settings are 15 minutes, 30 minutes, 1 hour, 2 hours, and 4 hours, respectively. It is understood that, the synchronization period settings can be set by the user of the mobile device.

When the monitored state reaches the corresponding threshold value, in step S5100, a synchronization period of the mail synchronization mechanism is set to the first synchronization period setting in the sequence. In step S5200, it is determined whether the synchronization period of the mail synchronization mechanism (the set synchronization period setting) expires. If the synchronization period of the mail synchronization mechanism does not expire (No in step S5200), the procedure remains at step S5200. If the synchronization period of the mail synchronization mechanism expires (Yes in step S5200), in step S5300, the mail application checks and receives mails from the server, and in step S5400, the synchronization period of the mail synchronization mechanism is set to a next synchronization period setting of the current synchronization period setting in the sequence. Then, the procedure goes to step S5200, and steps S5200 to S5400 repeats until the synchronization period of the mail synchronization mechanism is set to the last synchronization period setting in the sequence.

It is noted again, in some embodiments, when at least one unread mail in the mail box is been read or when the mail application is opened, the mail synchronization mechanism of the mail application is returned to the predefined mail synchronization mechanism. Similarly, the at least one unread mail in the mail box is determined to be read when a title or a body of the at least one unread mail is read.

It is understood that, when several mail accounts are in the mail application, each account should maintains its own sequence of synchronization period settings. Additionally, each account may have a peak-time sequence of synchronization period settings and a off-peak-time sequence of synchronization period settings, and the mail application runs according to the peak-time or the off-peak-time sequence of synchronization period settings based on a current time.

Therefore, the methods and systems of dynamic mail synchronization for mobile devices can dynamically adjust the mail synchronization mechanism of a mail application, and the corresponding synchronization period according to at least one state of the mail box, thereby reducing the times of mail synchronization to save power consumption for mobile devices.

Methods of dynamic mail synchronization for mobile devices, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method of dynamic mail synchronization for mobile devices for use in an electronic device, comprising:
monitoring at least one state of a mail box corresponding to a mail application on the electronic device, wherein the mail application has a predefined mail synchronization mechanism for checking and receiving mails from a server;
determining whether the monitored state reaches a corresponding threshold value; and
when the monitored state reaches the corresponding threshold value, adjusting the predefined mail synchronization mechanism of the mail application, such that the mail application periodically checks and receives mails from the server based on the adjusted mail synchronization mechanism.

2. The method of claim 1, wherein the at least one state comprises a number of unread mails in the mail box, a time interval between two successive mails, a period between receiving the first unread mail and the mail application is been launched, or a period between receiving the first unread mail and at least one mail is been read.

3. The method of claim 1, further comprising returning the mail synchronization mechanism of the mail application to the predefined mail synchronization mechanism when at least one unread mail in the mail box is been read or when the mail application is opened.

4. The method of claim 3, wherein the at least one unread mail in the mail box is determined to be read when a title or a body of the at least one unread mail is read.

5. The method of claim 2, wherein when the number of unread mails in the mail box is greater, a synchronization period of the mail synchronization mechanism is set longer.

6. The method of claim 2, wherein when the time interval between two successive mails is longer, a synchronization period of the mail synchronization mechanism is set longer.

7. The method of claim 2, wherein when the period between receiving the first unread mail and the mail application is been launched is longer, a synchronization period of the mail synchronization mechanism is set longer.

8. The method of claim 2, wherein when the period between receiving the first unread mail and at least one mail is been read is longer, a synchronization period of the mail synchronization mechanism is set longer.

9. The method of claim 1, wherein the method for adjusting the mail synchronization mechanism of the mail application comprises the steps of:
providing at least a first synchronization period setting and a second synchronization period setting, wherein the second synchronization period setting is longer than the first synchronization period setting;
when the monitored state reaches the corresponding threshold value, setting a synchronization period of the mail synchronization mechanism to the first synchronization period setting;
determining whether the first synchronization period setting expires; and
when the first synchronization period setting expires, setting the synchronization period of the mail synchronization mechanism to the second synchronization period setting.

10. The method of claim 9, wherein when the first synchronization period setting expires, the method further comprises first checking and receiving mails from the server based on the first synchronization period setting by the mail application, and thereafter setting the synchronization period of the mail synchronization mechanism to the second synchronization period setting.

11. The method of claim 1, wherein the predefined mail synchronization mechanism of the mail application comprises a push mail mechanism, and the mail application periodically checks and receives mails from the server based on the adjusted mail synchronization mechanism when at least one unread mail is received.

12. A system of dynamic mail synchronization for mobile devices for use in an electronic device, comprising:
a storage unit comprising a mail box corresponding to a mail application, wherein the mail application has a predefined mail synchronization mechanism for checking and receiving mails from a server; and
a processing unit monitoring at least one state of the mail box, determining whether the monitored state reaches a corresponding threshold value, and when the monitored state reaches the corresponding threshold value, adjusting the predefined mail synchronization mechanism of the mail application, such that the mail application periodically checks and receives mails from the server based on the adjusted mail synchronization mechanism.

13. The system of claim 12, wherein the at least one state comprises a number of unread mails in the mail box, a time interval between two successive mails, a period between receiving the first unread mail and the mail application is been launched, or a period between receiving the first unread mail and at least one mail is been read.

14. The system of claim 12, wherein the processing unit further returns the mail synchronization mechanism of the mail application to the predefined mail synchronization mechanism when at least one unread mail in the mail box is been read or when the mail application is opened.

15. The system of claim 14, wherein the processing unit determines the at least one unread mail in the mail box is been read when a title or a body of the at least one unread mail is read.

16. The system of claim 13, wherein when the number of unread mails in the mail box is greater, the processing unit sets a synchronization period of the mail synchronization mechanism longer.

17. The system of claim 13, wherein when the time interval between two successive mails is longer, the processing unit sets a synchronization period of the mail synchronization mechanism longer.

18. The system of claim 13, wherein when the period between receiving the first unread mail and the mail application is been launched is longer, the processing unit sets a synchronization period of the mail synchronization mechanism longer.

19. The system of claim 13, wherein when the period between receiving the first unread mail and at least one mail is been read is longer, the processing unit sets a synchronization period of the mail synchronization mechanism longer.

20. The system of claim 12, wherein the processing unit adjusts the mail synchronization mechanism of the mail application by setting a synchronization period of the mail synchronization mechanism to a first synchronization period setting when the monitored state reaches the corresponding threshold value, determining whether the first synchronization period setting expires, and setting the synchronization period of the mail synchronization mechanism to a second synchronization period setting when the first synchronization period setting expires, wherein the second synchronization period setting is longer than the first synchronization period setting.

21. The system of claim 20, wherein when the first synchronization period setting expires, the processing unit further first checks and receives mails from the server based on the first synchronization period setting by the mail application, and thereafter sets the synchronization period of the mail synchronization mechanism to the second synchronization period setting.

22. The system of claim 12, wherein the predefined mail synchronization mechanism of the mail application comprises a push mail mechanism, and the mail application periodically checks and receives mails from the server based on the adjusted mail synchronization mechanism when at least one unread mail is received.

23. A machine-readable storage medium comprising a computer program, which, when executed, causes a device to perform a method of dynamic mail synchronization for mobile devices, wherein the method comprises:
monitoring at least one state of a mail box corresponding to a mail application on the electronic device, wherein the mail application has a predefined mail synchronization mechanism for checking and receiving mails from a server;
determining whether the monitored state reaches a corresponding threshold value; and
when the monitored state reaches the corresponding threshold value, adjusting the predefined mail synchronization mechanism of the mail application, such that the mail application periodically checks and receives mails from the server based on the adjusted mail synchronization mechanism.
